(19) United States
(12) Patent Application Publication
(10) Pub. No.: US 2019/0039544 A1
(43) Pub. Date: Feb. 7, 2019

(54) Method for Transmitting and Receiving a Measured Value of a Sensor

(71) Applicant: Robert Bosch GmbH, Stuttgart (DE)

(72) Inventor: Marlon Ramon Ewert, Untergruppenbach (DE)

(21) Appl. No.: 15/999,309

(22) PCT Filed: Jan. 19, 2017
(86) PCT No.: PCT/EP2017/051046

§ 371 Date: Aug. 17, 2018

(30) Foreign Application Priority Data
Feb. 18, 2016 (DE) 10 2016 202 531.7

(51) Int. Cl. B60R 21/01; H04Q 9/00; B60R 21/36

(52) U.S. Cl. CPC B60R 21/01; H04Q 9/00; H04L 12/40; B60R 2021/01115; B60R 21/36

(57) ABSTRACT

A method for transmitting a measured value of a sensor using a first data word and at least one second data word includes reproducing a first part of the measured value in the first data word and reproducing a remaining part of the measured value in the at least one second data word, such that the reproduced parts of the measured value transition into one another.

The present invention relates to a method for transmitting a measured value of a sensor, to a corresponding method for receiving the measured value and to a sensor and a controller according to the independent claims.

Further aspects of the invention are a computer program and a machine-readable storage medium.

### PRIOR ART

DE 101 49 332 A1 discloses a method for digital data transmission from a sensor to a controller, in which the sensor values of the sensor are split at different resolutions for the data transmission. The sensor values form a first value range having successive sensor values. The first value range is split for the data transmission on the basis of a variable relevant to the controller.

Peripheral Sensor Interface 5 (PSI5) is an open standard and supports the polling of up to four sensors per bus node, said sensors being able to be polled in different configurations. There is also provision for bidirectional communication for sensor configuration and diagnosis.

In airbag systems, data from pressure or acceleration sensors, for example, are evaluated using current-modulated two-wire buses that communicate with the controller using a Manchester-coded protocol.

The possible types of operation are also stipulated in the standard. These are initially differentiated by synchronous and asynchronous modes of operation. In the case of the synchronous modes of operation, the following three types of operation arise according to the interconnection of the sensors with the control unit: Parallel BUS Mode (all sensors are connected in parallel), Universal BUS Mode (series interconnection of the sensors) and Daisy Chain BUS Mode. In combination with other parameters, such as total number of time slots, data rate, data word length, parity/CRC monitoring, the PSI5 standard permits different realization options. Use of the 10-bit data word length is widespread.

Sensors used today that implement the PSI5 standard normally use a firmly defined resolution for the measured value of a sensor channel on a single communication slot. This firmly defined resolution is normally constant for the entire capture range of the sensor.

A disadvantage of the practice hitherto is the necessary compromise between high measured value resolution and wide measurement range. By way of example, a present-day sensor that the PSI5 standard with a data word of 10 bits based on the standard supports either a high resolution with a narrow measurement range or a wide measurement range at low resolution. This is counterproductive particularly if one and the same sensor is used for different applications, the measurement ranges and resolutions for the different applications being fundamentally different and therefore incompatible with one another. This can particularly have a negative effect on the interpretation of algorithms (such as algorithms for triggering restraining means in airbag controllers, for example).

### DISCLOSURE OF THE INVENTION

Against this background, the present invention proposes a method for transmitting a measured value of a sensor, in which the measured value is transmitted by means of a first and at least one second data word, with a first portion of the measured value being mapped onto the first data word, and the remaining portion of the measured value being mapped onto the at least one second data word, such that the mapped portions of the measured value merge into one another.

In the present case, a measured value of a sensor is understood to mean a value that a sensor, which captures a physical event using applicable sensor means, for example, outputs as a voltage level or provides in digitized form as representative digital values.

In the present case, a data word is understood to mean the component of a data packet or data stream of a digital transmission protocol that carries the information to be transmitted. In the present case, this may be a representation of the sensor measured value to be transmitted.

In the present case, mapping of the sensor measured value onto a data word is understood to mean that the representation of the measured value is converted into a representation for the data word. This conversion can be depicted as a function within the context of the present invention. Such a function may be a mathematical function used to code straight lines, curves or functions describing the mapping of measured values of the sensor onto a data word.

Linear, nonlinear and nonsymmetric functions are conceivable.

The mapping is then effected either in software on the sensor or by means of logic within the sensor ASIC. Subsequently, the data word computed from the measured value is transmitted by a suitable communication means, for example on a communication bus.

A nonlinear function is intended to be understood in this case to mean a function that maps a measured value range at one resolution onto a value range that has different resolutions.

A nonsymmetric function is intended to be understood in the present case to mean a function that maps the measured value range onto a value range of the data word that is not set up symmetrically about the zero point.

In the present case, merging into one another is understood to mean that the original measured value is substantially restored from a recombination of the mapped portions of the measured value. In particular, this is intended to be understood to mean that initially the first data word, limited by the word length of the data word, is used to transmit a up to a maximum depictable value component of the measured value and the at least one second data word is used to transmit the remaining value component of the measured value.

If, for example limited by a word length of a data word of 10 bits, a data word can be used to transmit the values from −480 to +480, but the measured value to be transmitted assumes a value of +563, then initially the first data word is used to transmit the value component +480 and the at least one second data word is used to transmit the remaining value component +83.

Other transitions are also conceivable within the context of the present invention. By way of example, the measured value could be divided by the number of available data words.

Following on from the previous example, if two data words are available for transmission, the measured value to be transmitted could be divided by 2. The first data word is then used to transmit the value component +281 and the second data word is used to transmit the remaining value component +282.

An advantage of using two data words for transmission is the simple implementation of the division by 2 for measured values present in binary form.

Fundamentally, it is clear that in the case of measured values that are not divisible by the number of available data words, the remainder can be added to one of the data words—in the present example, the second data word.

Fundamentally, it is clear that this approach works with more than two available data words.

Other combinations and recombinations are also possible in the present case for splitting the measured value over data words available for transmission.

According to one embodiment of the method of the present invention, the at least one second data word is used to transmit only the components of the measured value that are situated either above or below the largest sensor value, in terms of absolute value, transmittable with the first data word.

An advantage of this embodiment is that it allows the measurement range to be increased unilaterally. This is of interest particularly in combination with applications that focus their operation on one measured value range.

As such, for applications for actuating restraining means for vehicle occupants, such as airbags and the like, for example, the negative acceleration values are more relevant than the positive acceleration values.

According to a further variant of the method of the present invention, the first data word represents the first portion of the measured value at a first resolution and the at least one second data word represents the at least one second portion of the measured value at at least one further resolution.

This variant has the advantage that the triggering of the data word used to transmit the applicable component of the measured value can be matched to the needs of the receiving application.

As such, in the case of actuation methods for personal protection means, such as airbags and the like, for example, there is a need to transmit the components of the measured value that are situated around threshold values relevant to an actuation decision at a higher resolution even if this means that the transmitted measured value range turns out to be smaller. Other components, by contrast, can be transmitted at a lower resolution in favor of a higher measured value range.

Of significance in this case is the variant according to which the first resolution is not equal to the at least one second resolution. In addition, it is expedient if the first resolution is higher than the at least one second resolution.

The advantageous aspects of the embodiments of the method of the present invention can be seen particularly when the first data word and the second data word have the same word length. When applying the method based on the specification of the PSI5 standard, a data word length of 10 bits is particularly significant.

The advantageous aspects of the embodiments of the method of the present invention are particularly effective if the first and the at least one second data word are transmitted using a communication protocol that has at least one communication slot for transmission.

A communication slot is intended in the present case to be understood to mean a particular period within a communication cycle in which the sender associated with this communication slot can send a message. As such, in a communication cycle that is 500 μs long and has 3 communication slots, each communication slot can last between approximately 123 μs and approximately 153 μs. The data transmission of the first slot takes place from the 44th-167.8th microsecond, the data transmission of the second slot takes place from the 181.3rd-319.6th microsecond and the data transmission of the third slot takes place from the 328th-482nd microsecond. The remaining microseconds serve as a buffer before the beginning of the first communication slot, after the conclusion of the last communication slot and between the communication slots. When reference is made to a communication slot in the present case, this means the allocated period of time within a communication cycle.

The transmission protocol based on the PSI5 standard is one such communication protocol.

When applying the present method in a communication protocol having the properties described above, it is an advantageous aspect of a variant of the method of the present invention if the first and the at least one second data word are transmitted in different communication slots or in succession within the same communication slot or in rolling fashion within the same communication slot.

An advantage of the first alternative of this variant, in which the first and the at least one second data word are transmitted in different communication slots, is that in communication configurations in which more communication slots than communication subscribers are available, unused communication slots are used for measured value transmission. In this manner, the available bandwidth is utilized better and a higher data rate is obtainable.

In succession within the same communication slot in the present case means that a first component of the communication slot is provided for transmission of the first data word and the remaining component is provided for the at least one second data word.

In rolling fashion within the same communication slot in the present case means that, by way of example, the first data word is transmitted in the first communication cycle in the applicable communication slot (e.g. the second communication slot). In the at least one further communication cycle, the at least one second data word is then transmitted in the applicable communication slot (according to the example the second communication slot). Sequentially until the first data word is transmitted in the second communication slot again. An advantage of these most recently described variants is that the PSI5 protocol almost does not need to be adapted therefor, and there is therefore a high level of compatibility with already existing variants of the protocol.

A further aspect of the present invention is a method for receiving a measured value of a sensor, in which the measured value is received by means of a first and at least one second data word, with a first portion of the measured value being received by means of the first data word and at least one second portion of the measured value being received by means of the at least one second data word, the received portions of the measured value merging into one another.

For this aspect of the present invention, there are the analogous variants and embodiments as for the method for transmitting a measured value of a sensor according to the present invention and the corresponding coordinate claim and subclaims.

In one advantageous embodiment of the method for receiving, the received measured value is transmitted by means of a method for transmitting a measured value according to the present invention.

A further aspect of the present invention is a sensor set up such that the sensor carries out all the steps of an embodiment of the method for transmitting a measured value according to the present illustration.

In an advantageous embodiment of the sensor, the sensor stores at least one function for mapping measured values onto data words.

To this end, the sensor can have suitable storage means.

According to a particular variant of this embodiment, the sensor transmits the function selected for mapping from the at least one stored function in an initialization phase.

According to this variant, use of the sensor of the present invention is distinctly simplified. Depending on the manner of use, the manner of use being intended to be understood to mean the sensor type (pressure or inertial sensor), the place of use (upfront sensor, side impact sensor, etc.), the type of use (crash detection, crash plausibilization, pedestrian impact detection), an applicable stored function can be selected that is transmitted during the initialization. Instead of the function per se or its mathematical representation, it is also conceivable for a value to be transmitted that explicitly identifies the selected function for the receiver.

A further aspect of the present invention is a method for manufacturing a sensor according to the present invention, in which the at least one function is stored in the sensor during manufacture.

An advantage of this method of manufacture is that the sensor is ready for use immediately after manufacture without configuration or adjustment of the sensor needing to be performed before use or installation.

The method of manufacture involves all the relevant functions for mapping being stored in the sensor during actual manufacture.

It would also be conceivable for the stored functions to be stored in the sensor in suitably protected fashion, for example in signed fashion, so that subsequent manipulation or alteration is not possible or at least does not remain undetected.

A further aspect of the present invention is a receiver of the transmission. In an advantageous embodiment of the receiver, the receiver stores at least one function for mapping data words onto measured values.

A further aspect of the present invention is a controller set up so as to carry out all the steps of the method for receiving a measured value of a sensor according to the present invention. Such a controller is a typical implementation of the aforementioned receiver.

A further aspect of the present invention is a computer program configured to carry out one of the methods of the present invention, and a machine-readable storage medium on which such a computer program is stored.

Embodiments of the present invention and particular aspects and advantages are clarified below on the basis of figures, in which

FIG. 1 shows a linear mapping of sensor measured values onto transmitted values of a communication protocol based on the prior art today;

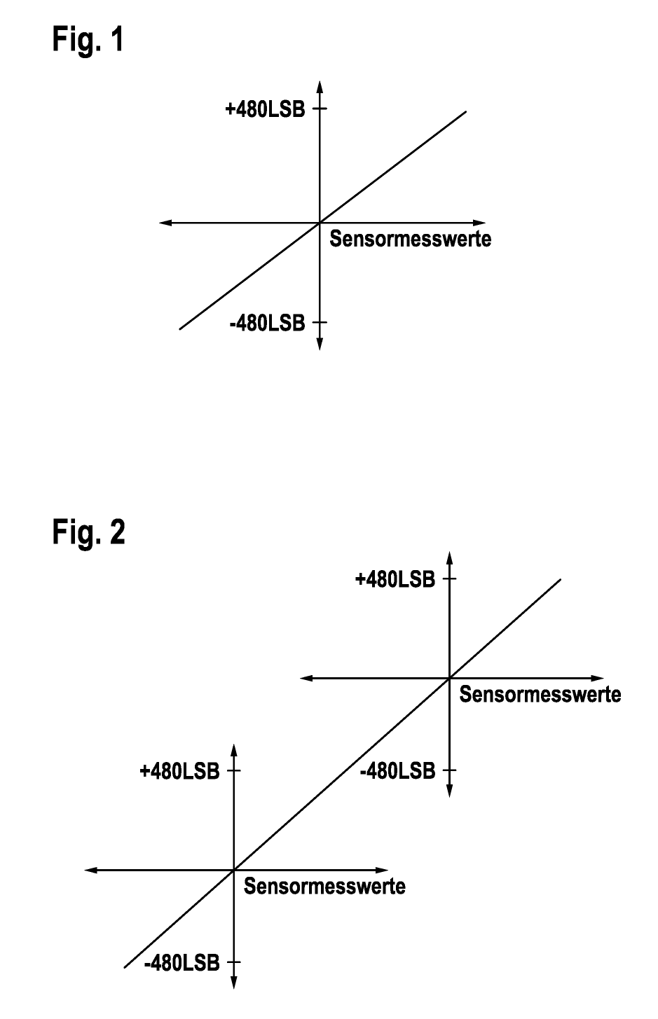

FIG. 2 shows a depiction of the transmission of sensor measured values according to a variant of the present invention;

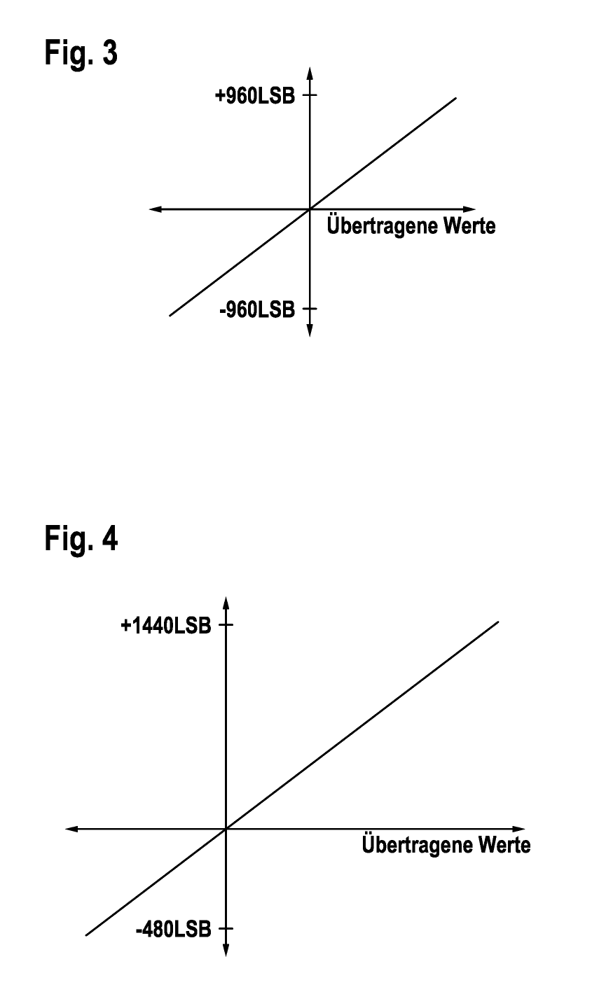

FIG. 3 shows a depiction of the receiving of sensor measured values according to a further variant of the present invention;

FIG. 4 shows a depiction of the receiving of sensor measured values according to a further variant of the present invention;

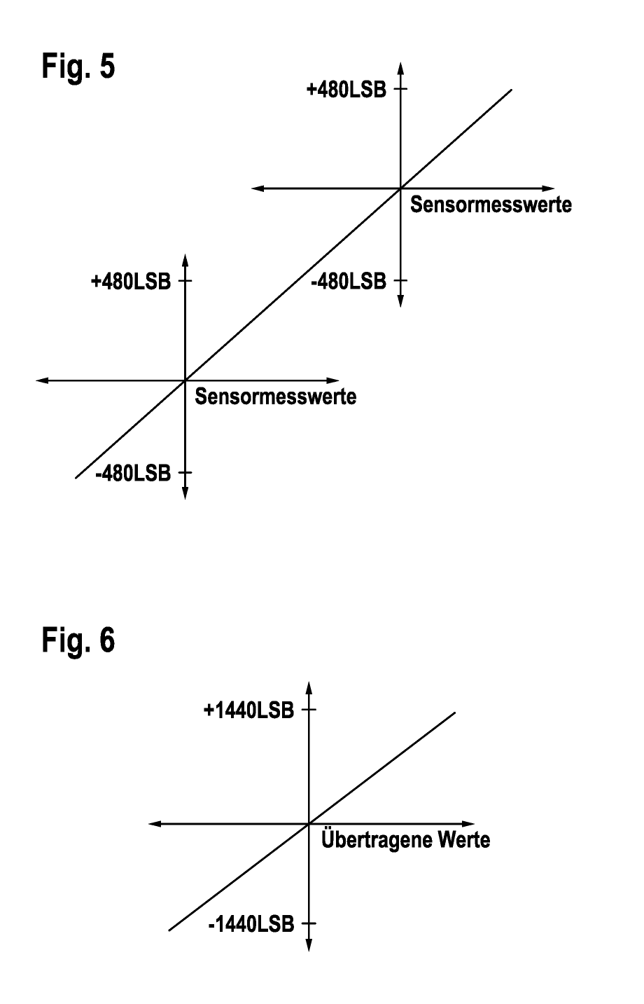

FIG. 5 shows a depiction of the transmission of sensor measured values according to a further variant of the present invention;

FIG. 6 shows a depiction of the receiving of sensor measured values according to a further variant of the present invention;

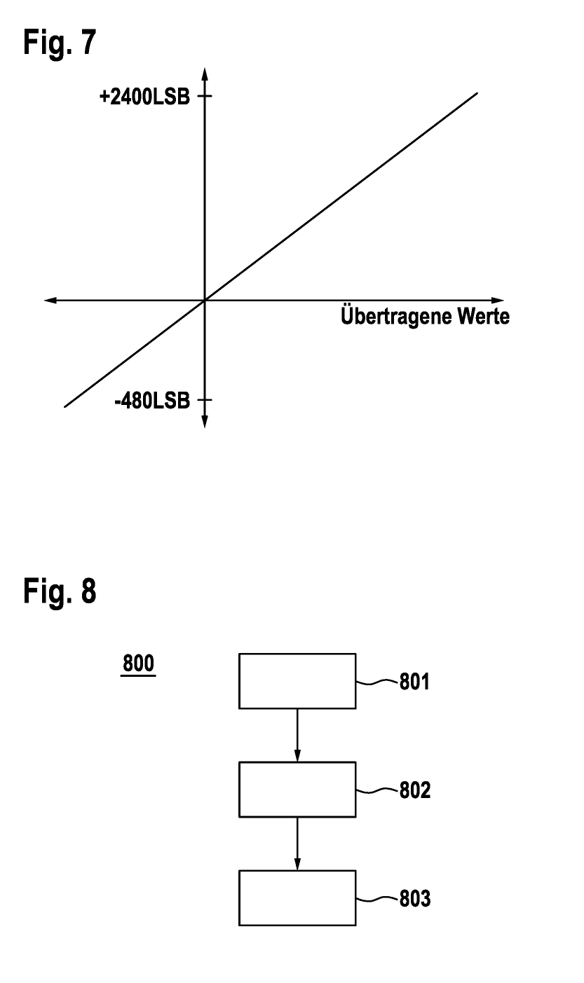

FIG. 7 shows a depiction of the receiving of sensor measured values according to a further variant of the present invention;

FIG. 8 shows a flowchart of an embodiment of a method for transmitting sensor measured values according to the present invention;

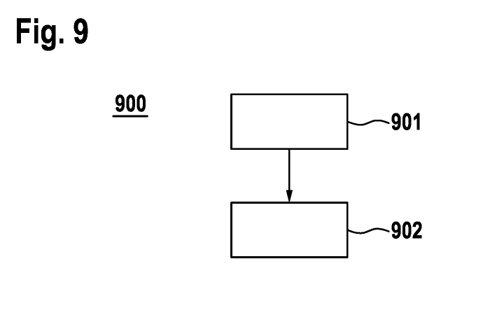

FIG. 9 shows a flowchart of an embodiment of a method for receiving sensor measured values according to the present invention.

FIG. 1 shows a linear mapping of sensor measured values onto data words for the purpose of transmitting the sensor measured values by means of a communication slot, for example on a communication slot based on the PSI5 protocol or on a point-to-point connection based on the prior art. In this case, the data range of a 10-bit sensor for a sensor channel as shown in FIG. 1 using the example of from −480 LSB to +480 LSB is formed linearly from the sensor measured values.

The abscissa plots the sensor measured values. The ordinate plots the values of the data word. The red line in this case represents the linear assignment of the sensor measured value range to the data word range of +/−480 LSB.

FIG. 2 shows how a measured value of the sensor is initially transmitted up to a range of +/−480 LSB in a first communication slot. Subsequently, further sensor measured values are transmitted in at least one further communication slot of the same communication bus. The sensor measured values of the second communication slot may in this case be coded differently, as described below, for the purpose of measurement range extension. It is important that the sensor measured values for the different communication slots merge into one another. The merging into one another as shown in FIG. 2 can be regarded merely as an example.

In the next step, the sensor signals of the communication bus are received and processed for the various communication slots on a controller (for example an airbag controller), for example. So that the sensor signals of the communication bus are interpreted on the controller correctly, the invention involves the sensor signals of the communication slot used in the communication protocol being converted.

FIG. 3 shows how the addition of the values transmitted by means of the data words, for example within the first and second communication slots, can realize a measurement range extension by the factor 2 in the positive and negative directions (symmetrically).

In FIG. 3, the addition of the transmitted values from the two communication slots, depicted in FIG. 2, therefore a single straight line again in the controller. However, it is apparent that the value range on the controller, at +/−960 LSB, is now distinctly above the value range on the first communication slot of the sensor bus (+/−480 LSB). The addition of the values of the two communication slots therefore allows an extended measurement range to be transmitted using a suitable communication means, for example a PSI5 bus, within the framework of the invention. In this example, the communication means is only able to transmit +/−480 LSB for a data word size of 10 bits. The combination of multiple communication slots and the conversions at the sensor and controller ends mean that this results in +/−960 LSB in this example, however. The resolution of the sensor signals is the same for both communication slots in this example.

It is clear to a person skilled in the art in this case that the value ranges is dependent on the data word length of the communication slots and the number of communication slots used.

FIG. 4 shows how the combination of the transmitted values of the first and second communication slots realizes a measurement range extension for the sensor by the factor 3 in the positive direction (asymmetrically).

In FIG. 4, the transmitted values have continued to be transmitted between +/−480 LSB as shown in FIG. 2 on the second communication slot. However, the data have been coded on the sensor prior to transmission such that only positive sensor signals above +480 LSB are transmitted in coded fashion in the second communication slot. This means that the second communication slot contains sensor measured values between +481 LSB and +1440 LSB in this case. This means that the combination of the transmitted values from the two communication slots, as illustrated in FIG. 4, results in a single straight line again in the controller. However, it is apparent that the value range on the controller, at −480 LSB to +1440 LSB, is now distinctly above the value range on the first communication slot of the communication protocol (+/−480 LSB). The combination of the transmitted values of the two communication slots therefore allows an extended measurement range to be transmitted on a PSI5 bus within the framework of the invention. In this example, the first communication slot of the communication means is only able to transmit measured values between +/−480 LSB for a data word size of 10 bits. The combination of multiple communication slots and the conversions at the sensor and controller ends mean that this results in −480 LSB to +1440 LSB in this example, however. The resolution of the sensor signals is the same for both communication slots in this example. The asymmetric layout of the value range is intended in this case, since for some applications a high measurement range may be needed only in the positive sensing range of the sensor.

It is clear to a person skilled in the art in this case that the measurement range can be increased into the negative sensing range of the sensor in an analogous manner.

According to the embodiments above, the sensor measured values have been transferred to a first and at least one second data word at the same resolution.

According to the embodiments that are now described below, the aim is for the transmitted value range to be extended as appropriate by means of different resolutions of the measured values in the first and at least one second data word.

According to these embodiments of the method of the present invention, the addition of at least one further communication slot effects a measurement range extension, the resolution of the transmitted values on the second communication slot not being consistent with the resolution of the transmitted values on the first communication slot. The characteristic curve depicted in FIG. 5, which characteristic curve is plotted in a fashion distributed over two communication slots, is intended to clarify the principle:

According to the depiction in FIG. 5, the sensor measured values of the sensor are initially transmitted up to a range of +/−480 LSB on the first communication slot of an applicable communication protocol or standard. Subsequently, further sensor measured values are transmitted in at least one further communication slot of the same communication protocol or standard. The sensor measured values of the second communication slot may in this case be coded differently, as described below, for the purpose of measurement range extension. It is important that the sensor measured values in this case, as shown in FIG. 5, have a different resolution for the different communication slots in this example, but their value ranges merge into one another.

In the next step, the transmitted values of the applicable communication protocol or standard are received and processed for the various communication slots, for example on a controller (in this case an airbag controller). So that the sensor signals of the communication bus are interpreted on the controller correctly, the invention involves the sensor signals of the communication slot used in the applicable communication protocol or standard being converted. In this context, multiple methods of coding on the sensor or back-calculation on the controller are conceivable. Some of these are presented below by way of example.

FIG. 6 shows how the addition of the signal values of the first and second communication slots realizes a measurement range extension for the sensor by the factor 3 in the positive and negative directions (symmetrically).

According to the variant, as depicted in FIG. 6, the addition of the transmitted values from the two communication slots as shown in FIG. 5 therefore a single straight line again in the controller. However, it is apparent that the value range on the controller, at +/−1440 LSB by way of example, is now distinctly above the value range on a single communication slot (+/−480 LSB). The addition of the sensor signals of the two communication slots therefore allows an extended measurement range to be transmitted using the communication protocol or standard within the framework of the invention. In this example, the communication protocol provides for a data word size of 10 bits. It is therefore only possible to transmit +/−480 LSB. The combination of multiple communication slots, with the second communication slot being operated only at half resolution in this example and the conversions being effected at the sensor and control ends, means that a value range of +/−1440 LSB is thus covered according to the present example.

The resolution of the transmitted values is different for the two communication slots in this example.

In the present case, this means the following: it is assumed a sensor has a sensing range that is mapped onto the value range of +/−1440 LSB in single steps.

However, only communication slots that have a data word size of 10 bits and therefore cover only a value range of +/−480 LSB in single steps are available for transmitting the sensor measured value.

In order to transmit the entire sensing range, the resolution 3:1 would now need to be chosen in the present case. This would mean accuracy would be lost.

If the correspondingly high resolution is significant, the sensing range could be trimmed. This is to say that measured values above/below +/−480 would not be transmitted or would be transmitted only as +/−480 LSB.

If both the resolution and the sensing range are important, then, according to one of the preceding embodiments, a further communication slot could be included. However, even two communication slots would only be able to cover a value range of +/−960 LSB.

According to the present variant, a predetermined value range could be transmitted at a high resolution. The high resolution could be dispensed with in the remaining value range.

In the case of applications for triggering safety means, such as airbags, a value range around the zero point or around the trigger threshold values is particularly significant. There should therefore be a high resolution around this value.

According to the present embodiment of the present invention, this is achieved by virtue of the sensor measured values between +/−480 being transmitted at a high resolution (for example 1:1), whereas the sensor measured values from −1440 to −481 and +481 to +1140 are transmitted at a lower resolution (for example 2:1).

By way of example, the sensor measured value +363 would be transmitted in the first communication slot with +363 LSB and in the second communication slot with 0.

On the controller, the sensor measured value +363 would be able to be received by addition of the transmitted values.

The sensor measured value −1221 would be transmitted in the first communication slot with −480 LSB and in the second communication slot, on account of the lower resolution and on account of rounding conventions, with −371 LSB.

On the controller, the sensor measured value −1222 would be received by addition and consideration of the different resolutions of the transmitted value in the second communication slot.

It is apparent in this case that the measured value and the received value are slightly different on account of the loss of information as a result of the lower resolution.

This loss of information is accepted in favor of the distinctly increased measured value range.

It is clear to a person skilled in the art in the present case that the measured value range can be influenced further by including further communication slots and by changing the resolution.

FIG. 7 shows how the combination of the transmitted values of the first and second communication slots realizes a measurement range extension for the sensor by the factor 5 in the positive direction (asymmetrically).

As shown in the depiction in FIG. 7, the transmitted values have continued to be transmitted between +/−480 LSB, as depicted in FIG. 5, on the second communication slot. However, the values have been coded on the sensor prior to transmission such that only positive sensor measured values above +480 LSB are transmitted in the second communication slot at a different resolution of the sensor measured values (as explained in regard to FIG. 6). In this example, the resolution of the sensor measured values of the second communication slot is only half as great as in the first communication slot. This means that the second communication slot contains sensor measured values between +481 LSB and +2400 LSB in this case.

This means that the combination of the transmitted values from the two communication slots, as depicted in FIG. 7, results in a single straight line again in the controller. However, it is apparent that the value range on the controller now stretches from −480 LSB to +2400 LSB and is thus distinctly above the value range of +/−480 LSB on the first communication slot of the communication protocol or standard. The combination of the transmitted values of the two communication slots therefore allows an extended measurement range to be transmitted by means of an applicable communication protocol, for example based on the PSI5 standard, within the framework of the invention.

A communication slot of the communication protocol or standard having a data word size of 10 bits in this example is only able to transmit +/−480 LSB. The combination of multiple communication slots and the conversions at the sensor and controller ends mean that this results in −480 LSB to +2400 LSB in this example, however.

The resolution of the sensor signals is different for the two communication slots in this example.

The asymmetric layout of the value range is intended in this case, since a high measurement range may also be needed only in the positive or negative sensing range of the sensor.

Moreover, the sensor resolution for the upper sensing range may be reduced, since a resolution in the single LSB range is for the most part not necessary there.

Beyond the cited approaches, it is conceivable within the framework of the invention for different mapping functions to be stored in the sensor and in the controller for a sensor generation. Depending on the application, the correct mapping function, i.e. the stipulation of the desired resolution for the applicable value ranges, is coded in the sensor during production.

The sensor configuration is subsequently sent to the controller during the initialization phase, so that the back-calculation of the sensor data from the transmission is performed correctly for the various communication slots in the controller.

In this manner, sensors arranged for an application for triggering occupant protection means, for example airbags, in the vehicle side, for example, can be operated at a different resolution or with a different value range than sensors of the same type for pedestrian protection or for front crash detection.

FIG. 8 shows a flowchart of an embodiment of a method for transmitting sensor measured values according to the present invention.

In step 801, a sensor measured value is output or provided by a sensor.

In step 802, the sensor measured value is mapped onto a first data word and at least one second data word, a first portion of the sensor measured value being mapped onto the first data word and the remaining portion of the sensor measured value being mapped onto the at least one second data word. In this case, the first mapped portion of the sensor measured value and the remaining mapped portion of the sensor measured value merge into one another.

In step 803, the first data word is transmitted by means of a first communication slot of an applicable communication protocol or standard and the at least one second data word is transmitted by means of at least one second communication slot of the communication protocol or standard, or the first and second data words are transmitted in succession within the same communication slot or the first and second data words are transmitted in rolling fashion within the same communication slot.

FIG. 9 shows a flowchart of an embodiment of the method for receiving a sensor measured value according to the present invention.

In step 901, a first and at least one second data word are received by means of a first communication slot and at least one second communication slot or in succession within the same communication slot or in rolling fashion within the same communication slot of an applicable communication protocol.

In step 901, the values transmitted by means of the first and the at least one second data word are combined as appropriate, so that the sensor measured value provided for transmission is received taking into consideration the transmitted value range and the resolution used.

1. A method for transmitting a measured value of a sensor, comprising:
mapping a first portion of the measured value onto a first data word;
mapping a remaining portion of the measured value onto at least one second data word; and
transmitting the measured value as the first data word and the at least one second data word, such that the mapped portions of the measured value merge into one another.

2. The method as claimed in claim 1, further comprising:
using the at least one second data word to transmit only components of the measured value that are situated either above or below a largest sensor value, in terms of absolute value, transmittable with the first data word.

3. The method as claimed in claim 1, wherein:
the first data word represents the first portion of the measured value at a first resolution, and
the at least one second data word represents the remaining portion of the measured value at at least one further resolution.

4. The method as claimed in claim 3, wherein the first resolution is not equal to the at least one further resolution.

5. The method as claimed in claim 1, wherein the first data word and the at least one second data word have the same word length.

6. The method as claimed in claim 1, further comprising:
transmitting the first data word and the at least one second data word according to a communication protocol, the communication protocol having at least one communication slot for transmission, with the first data word and the at least one second data word transmitted in different communication slots or in succession within the same communication slot or in rolling fashion within the same communication slot.

7. A method for receiving a measured value of a sensor, comprising:
receiving a first portion of the measured value based on a first data word; and
receiving a remaining portion of the measured value based on at least one second data word,
wherein the received portions of the measured value merge into one another.

8. The method as claimed in claim 7, further comprising:
using the at least one second data word to receive only components of the measured value that are situated either above or below a largest sensor value, in terms of absolute value, transmittable with the first data word.

9. The method as claimed in claim 7, wherein:
the first data word represents the first portion of the measured value at a first resolution, and
the at least one second data word represents the remaining portion of the measured value at at least one further resolution.

10. The method as claimed in claim 9, wherein the first resolution is not equal to the at least one further resolution.

11. The method as claimed in claim 7, wherein the first data word and the at least one second data word have the same word length.

12. The method as claimed in claim 7, further comprising:
receiving the first data word and the at least one second data word according to a communication protocol, the communication protocol having at least one communication slot for receiving, with the first data word and the at least one second data word received from different communication slots or in succession from the same communication slot or in rolling fashion from the same communication slot.

13. The method as claimed in claim 7, wherein the measured value is transmitted by
mapping the first portion of the measured value onto the first data word;
mapping the remaining portion of the measured value onto the at least one second data word; and
transmitting the measured value as the first data word and the at least one second data word, such that the mapped portions of the measured value merge into one another.

14. A sensor comprising:
at least one storage device configured to store at least one function for mapping a measured value onto a first data word and at least one second data word,
wherein the sensor is configured to transmit the measured value by
mapping a first portion of the measured value on the first data word,
mapping a remaining portion of the measured value onto the at least one second data word, and
transmitting the measured value as the first data word and the at least one second data word, such that the mapped portions of the measured value merge into one another.

15. (canceled)

16. The sensor as claimed in claim 14, wherein the sensor is configured to transmit the at least one function in an initialization phase.

17. The sensor as claimed in claim 14, wherein the at least one function is stored during manufacture of the sensor.

18. The sensor as claimed in claim 17, wherein the stored at least one function is stored in a protected fashion, such that retrospective manipulation and/or alteration of the at least one function is not possible.

19. The method as claimed in claim 7, wherein a controller is configured to carry out all the steps of the method.

20. The method as claimed in claim 1, wherein a computer program is configured to carry out the method.

21. The method as claimed in claim 20, wherein the computer program is stored on a machine-readable storage medium.
